(19) United States
(12) Patent Application Publication
(10) Pub. No.: US 2006/0042895 A1
(43) Pub. Date: Mar. 2, 2006

(54) Base cup connection for shock absorber

(76) Inventors: Gert Mangelschots, Heusden-Zolder (BE); M'Hand Nait Oukhedou, Bree (BE)

Correspondence Address: HARNESS, DICKEY & PIERCE, P.L.C., P.O. BOX 828, BLOOMFIELD HILLS, MI, 48303, US

(21) Appl. No.: 10/925,283

(22) Filed: Aug. 24, 2004

(51) Int. Cl. F16F 9/00

(52) U.S. Cl. 188/322.19; 188/322.22

(57) ABSTRACT

A shock absorber has a tube which is closed at one end with a base cup. The base cup defines an attachment bore within which the tube is located. A clearance is formed between the bottom of the tube located within the attachment bore and the bottom of the bore. This clearance improves the high load durability of the shock absorber by eliminating and/or reducing the notch effect.

### FIELD OF THE INVENTION

The present invention relates generally to shock absorbers and the connection between the base cup and one of the tubes of the shock absorber. More particularly, the present invention relates to a base cup to tube connection for a shock absorber which improves the performance of the shock absorber.

### BACKGROUND OF THE INVENTION

Shock absorbers are used in conjunction with automotive suspension systems and other suspension systems to absorb unwanted vibrations which occur during movement of the suspension system. In order to absorb these unwanted vibrations, automotive shock absorbers are generally connected between the sprung mass (the body) and the unsprung mass (the suspension/chassis) of the vehicle.

The most common type of shock absorber for the automotive industry is the dashpot type in which a piston is located within a pressure tube. The piston is typically connected to the sprung mass of the vehicle through a piston rod. The piston divides the pressure tube into an upper working chamber and a lower working chamber. Because the piston, through valving, has the ability to limit the flow of damping fluid between the upper and lower working chambers within the pressure tube when the shock absorber is compressed or extended, the shock absorber is able to produce a damping force which counteracts the vibrations which would otherwise be transmitted from the unsprung mass to the sprung mass. In a dual tube shock absorber, a fluid reservoir is defined between the pressure tube and a reserve tube which is positioned around the pressure tube. A base valve assembly is located between the lower working chamber and the fluid reservoir to also produce a damping force which counteracts the vibration which would otherwise be transmitted from the unsprung mass to the sprung mass of the automobile during stroking of the shock absorber.

Typical shock absorbers utilize a base cup which is welded to the end of the pressure tube in a mono-tube shock absorber and welded to the end of the reserve tube in a dual tube shock absorber. The base cup is designed to seal the end of the respective tube and to provide for a configuration which can easily be attached to the unsprung mass of the vehicle. The welded attachment between the base cup and the respective tube must be able to achieve specific life tests. For high load shock absorbers, where the range of forces on the weld are significantly higher than normal, the prior art welding designs can create a notch effect which will then cause the mode of failure as being a broken tube.

While these prior art welding designs have performed effectively in the various applications, the continued development of shock absorbers has included the increase in durability of the welding connection between the base cup and the tube of the shock absorber.

### SUMMARY OF THE INVENTION

The present invention provides the art with a base cup to tube welding design which avoids and/or delays the notch effect to provide a significant improvement to its performance. The end of the tube is designed to be assembled into the base cup with a space being provided between the end of the tube and the bottom of the aperture in the base cup. The providing of a space between the end of the tube and the aperture in the base cup avoids internal stress after welding of the tube and the base cup. This provides a significant increase in the life of the assembly under high load conditions.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic representation of a typical automobile which incorporates the welded base cup and tube in accordance with the present invention;

FIG. 2 is a side sectional view of the double tube shock absorber in accordance with the present invention;

FIG. 3 is an enlarged cross-sectional view of the piston assembly illustrated in FIG. 2;

FIG. 4 is an enlarged cross-sectional view of the attachment of the base cup in FIG. 2 in accordance with the present invention;

FIG. 5 is a side sectional view of a single tube shock absorber in accordance with the present invention; and

FIG. 6 is an enlarged cross-sectional view of the attachment of the base cup in FIG. 5 in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

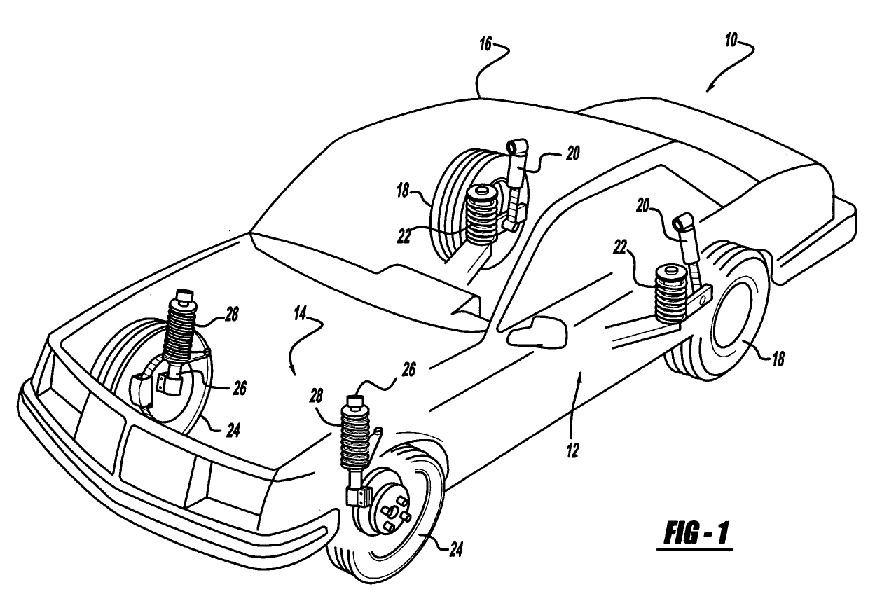

Referring now to the drawings in which like reference numerals designate like or corresponding parts throughout the several views, there is shown in FIG. 1 a vehicle incorporating a suspension system incorporating the shock absorbers in accordance with the present invention and which is designated generally by the reference numeral 10. Vehicle 10 includes a rear suspension 12, a front suspension 14 and a body 16. Rear suspension 12 has a transversely extending rear axle assembly (not shown) adapted to operatively support a pair of rear wheels 18 of vehicle 10. The rear axle assembly is operatively connected to body 16 by means of a pair of shock absorbers 20 and a pair of helical coil springs 22. Similarly, front suspension 14 includes a transversely extending front axle assembly (not shown) to operatively support a pair of front wheels 24 of vehicle 10. The front axle assembly is operatively connected to body 16 by means of a second pair of shock absorbers 26 and by a pair of helical coil springs 28. Shock absorbers 20 and 26 serve to dampen the relative motion of the unsprung mass (i.e., front and rear suspensions 12 and 14, respectively) and the sprung mass (i.e., body 16) of vehicle 10. While vehicle 10 has been depicted as a passenger car having front and rear axle assemblies, shock absorbers 20 and 26 may be used with other types of vehicles or in other types of applications such as vehicle incorporating independent front and/or independent rear suspension systems. Further, the term “shock absorber” as used herein is meant to refer to dampers in general and thus will include MacPherson struts.

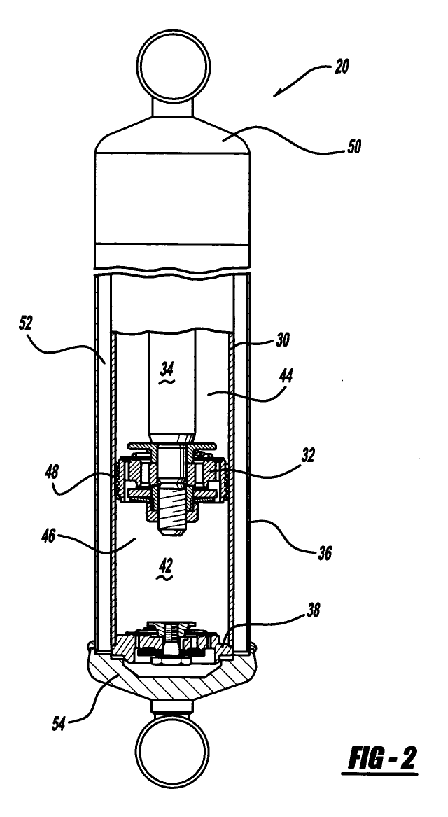

Referring now to FIG. 2, shock absorber 20 is shown in greater detail. While FIG. 2 illustrates only shock absorber 20, it is to be understood that shock absorber 26 also includes the base cup and tube welding described below for shock absorber 20. Shock absorber 26 only differs from shock absorber 20 in the manner in which it is adapted to be connected to the sprung and unsprung masses of vehicle 10. Shock absorber 20 comprises a pressure tube 30, a piston assembly 32, a piston rod 34, a reserve tube 36 and a base valve assembly 38.

Pressure tube 30 defines a working chamber 42. Piston assembly 32 is slidably disposed within pressure tube 30 and divides working chamber 42 into an upper working chamber 44 and a lower working chamber 46. A seal 48 is disposed between piston assembly 32 and pressure tube 30 to permit sliding movement of piston assembly 32 with respect to pressure tube 30 without generating undue frictional forces as well as sealing upper working chamber 44 from lower working chamber 46. Piston rod 34 is attached to piston assembly 32 and extends through upper working chamber 44 and through upper end cap 50 which closes the upper end of pressure tube 30. A sealing system seals the interface between upper end cap 50, reserve tube 36 and piston rod 34. The end of piston rod 34 opposite to piston assembly 32 is adapted to be secured to the sprung mass of vehicle 10. Valving within piston assembly 32 controls the movement of fluid between upper working chamber 44 and lower working chamber 46 during movement of piston assembly 32 within pressure tube 30. Because piston rod 34 extends only through upper working chamber 44 and not lower working chamber 46, movement of piston assembly 32 with respect to pressure tube 30 causes a difference in the amount of fluid displaced in upper working chamber 44 and the amount of fluid displaced in lower working chamber 46. The difference in the amount of fluid displaced is known as the “rod volume” and it flows through base valve assembly 38.

Reserve tube 36 surrounds pressure tube 30 to define a fluid reservoir chamber 52 located between tubes 30 and 36. The bottom end of reserve tube 36 is closed by a base cup 54 which is adapted to be connected to the unsprung mass of vehicle 10. The upper end of reserve tube 36 is attached to upper end cap 50. Base valve assembly 38 is disposed between lower working chamber 46 and reservoir chamber 52 to control the flow of fluid between chambers 46 and 52. When shock absorber 20 extends in length, an additional volume of fluid is needed in lower working chamber 46 due to the “rod volume” concept. Thus, fluid will flow from reservoir chamber 52 to lower working chamber 46 through base valve assembly 38 as detailed below. When shock absorber 20 compresses in length, an excess of fluid must be removed from lower working chamber 46 due to the “rod volume” concept. Thus, fluid will flow from lower working chamber 46 to reservoir chamber 52 through base valve assembly 38 as detailed below.

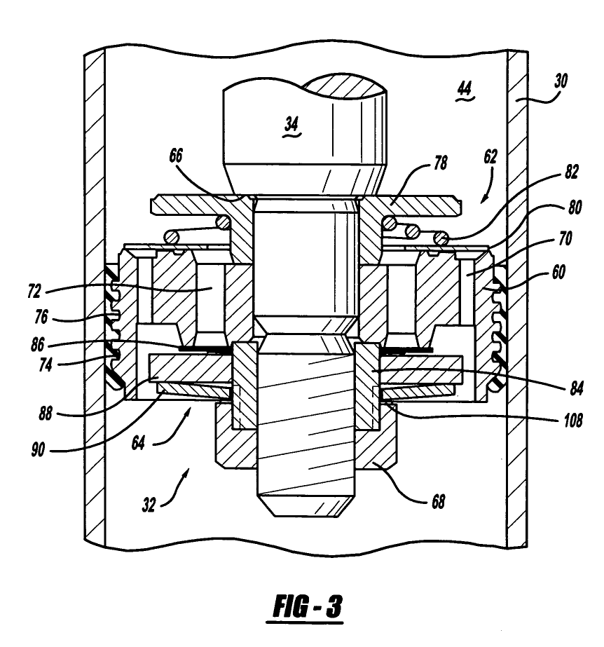

Referring now to FIG. 3, piston assembly 32 comprises a piston body 60, a compression valve assembly 62 and a rebound valve assembly 64. Compression valve assembly 62 is assembled against a shoulder 66 on piston rod 34. Piston body 60 is assembled against compression valve assembly 62 and rebound valve assembly 64 is assembled against piston body 60. A nut 68 secures these components to piston rod 34.

Piston body 60 defines a plurality of compression passages 70 and a plurality of rebound passages 72. Seal 48 includes a plurality of ribs 74 which mate with a plurality of annular grooves 76 to permit sliding movement of piston assembly 32.

Compression valve assembly 62 comprises a retainer 78, a valve disc 80 and a spring 82. Retainer 78 abuts shoulder 66 on one end and piston body 60 on the other end. Valve disc 80 abuts piston body 60 and closes compression passages 70 while leaving rebound passages 72 open. Spring 82 is disposed between retainer 78 and valve disc 80 to bias valve disc 80 against piston body 60. During a compression stroke, fluid in lower working chamber 46 is pressurized causing fluid pressure to react against valve disc 80. When the fluid pressure against valve disc 80 overcomes the biasing load of spring 82, valve disc 80 separates from piston body 60 to open compression passages 70 and allow fluid flow from lower working chamber to upper working chamber. Typically spring 82 only exerts a light load on valve disc 80 and compression valve assembly 62 acts like a check valve between chambers 46 and 44. The damping characteristics for shock absorber 20 are controlled by base valve assembly 38 which accommodates the flow of fluid from lower working chamber 46 to reservoir chamber 52 due to the “rod volume” concept. During a rebound stroke, compression passages 70 are closed by valve disc 80.

Rebound valve assembly 64 comprises a spacer 84, a plurality of valve discs 86, a retainer 88 and a Belleville spring 90. Spacer 84 is threadingly received on piston rod 34 and is disposed between piston body 60 and nut 68. Spacer 84 retains piston body 60 and compression valve assembly 62 while permitting the tightening of nut 68 without compressing either valve disc 80 or valve discs 86. Retainer 78, piston body 60 and spacer 84 provide a continuous solid connection between shoulder 66 and nut 68 to facilitate the tightening and securing of nut 68 to spacer 84 and thus to piston rod 34. Valve discs 86 are slidingly received on spacer 84 and abut piston body 60 to close rebound passages 72 while leaving compression passages 70 open. Retainer 88 is also slidingly received on spacer 84 and it abuts valve discs 86. Belleville spring 90 is assembled over spacer 84 and is disposed between retainer 88 and nut 68 which is threadingly received on spacer 84. Belleville spring 90 biases retainer 88 against valve discs 86 and valve discs 86 against piston body 60. When fluid pressure is applied to discs 86, they will elastically deflect at the outer peripheral edge to open rebound valve assembly 64. A shim 108 is located between nut 68 and Belleville spring 90 to control the preload for Belleville spring 90 and thus the blow off pressure as described below. Thus, the calibration for the blow off feature of rebound valve assembly 64 is separate from the calibration for compression valve assembly 62.

During a rebound stroke, fluid in upper working chamber 44 is pressurized causing fluid pressure to react against valve discs 86. When the fluid pressure reacting against valve discs 86 overcomes the bending load for valve discs 86, valve discs 86 elastically deflect opening rebound passages 72 allowing fluid flow from upper working chamber 44 to lower working chamber 46. The strength of valve discs 86 and the size of rebound passages will determine the damping characteristics for shock absorber 20 in rebound. When the fluid pressure within upper working chamber 44 reaches a predetermined level, the fluid pressure will overcome the biasing load of Belleville spring 90 causing axial movement of retainer 88 and the plurality of valve discs 86. The axial movement of retainer 88 and valve discs 86 fully opens rebound passages 72 thus allowing the passage of a significant amount of damping fluid creating a blowing off of the fluid pressure which is required to prevent damage to shock absorber 20 and/or vehicle 10.

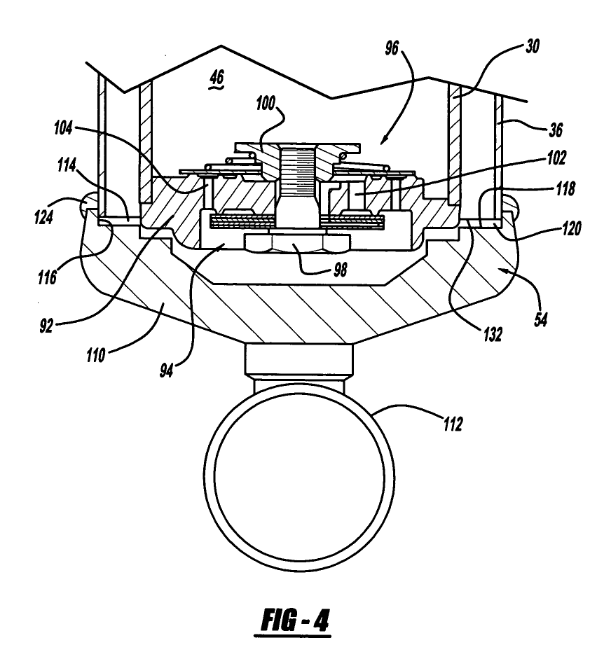

Referring to FIG. 4, base valve assembly 38 comprises a valve body 92, a compression valve assembly 94 and a rebound valve assembly 96. Compression valve assembly 94 and rebound valve assembly 96 are attached to valve body 92 using a bolt 98 and a nut 100. Valve body 92 defines a plurality of compression passages 102 and a plurality of rebound passages 104.

During a compression stroke, fluid in lower working chamber 46 is pressurized and the fluid pressure within compression passages 102 will eventually open compression valve assembly 94 by deflecting the discs in a manner similar to that described above for rebound valve assembly 64. Compression valve assembly 62 will allow fluid flow from lower working chamber 46 to upper working chamber 44 and only the “rod volume” will flow through compression valve assembly 94. The damping characteristics for shock absorber 20 are determined by the design of compression valve assembly 94 of base valve assembly 38.

During a rebound stroke, rebound valve assembly 96 acts as a check valve to allow the “rod volume” fluid to flow from reservoir chamber 52 through rebound passages 104 and into lower working chamber 46.

Referring now to FIG. 4, the attachment between base cup 54 and reserve tube 36 is shown in greater detail. Base cup 54 comprises a cup shaped end cap 110 and a cylindrical attachment collar 112. Collar 112 is illustrated as being welded to end cap 110 but other attachment means or an integral construction can be utilized for collar 112 and end cap 110. End cap 110 defines a mounting bore 114 having an inner cylindrical wall 116 and an annular end wall 118. Reserve tube 36 is inserted into mounting bore 114 such that it does not abut end wall 118. A clearance 120 is maintained between the end 122 of reserve tube 36 and end wall 118. A press fit between reserve tube 36 and cylindrical wall 116 may be provided. Once properly positioned to define clearance 120, end cap 110 and reserve tube 36 are welded as illustrated at 124 such that end cap 110 seals reserve tube 36.

By providing clearance 120, the notch effect is avoided and/or delayed to provide significant improvement in the endurance performance characteristics at high loads for shock absorber 20.

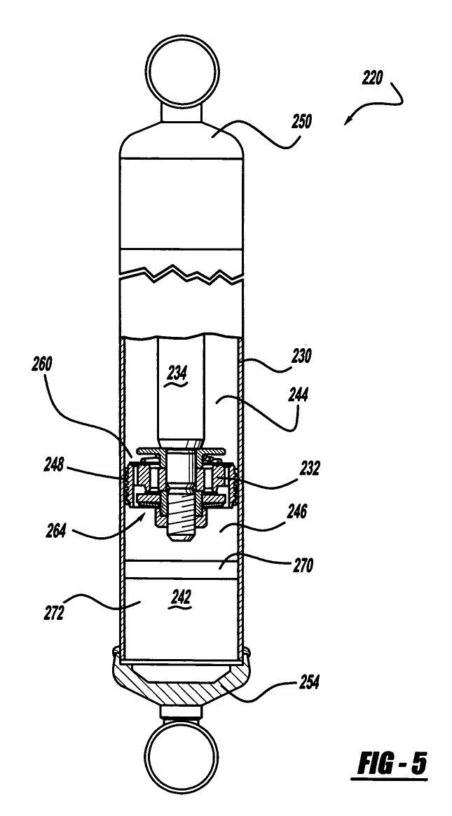

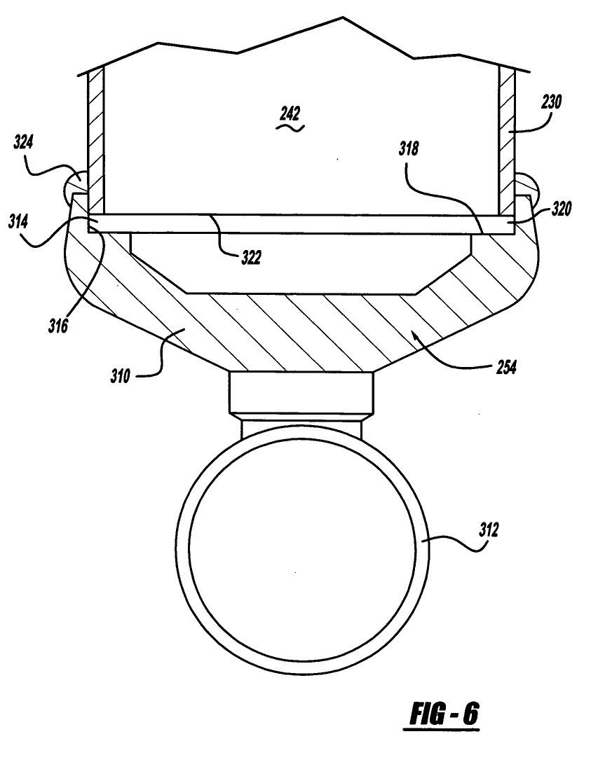

Referring now to FIG. 5 and 6, a mono-tube shock absorber 220 in accordance with the present invention is illustrated. Shock absorber 220 can replace either shock absorber 20 or shock absorber 26 by modifying the way it is adapted to be connected to the sprung mass and/or the unsprung mass of the vehicle. Shock absorber 220 comprises a pressure tube 230, a piston assembly 232 and a piston rod 234.

Pressure tube 230 defines a working chamber 242. Piston assembly 232 is slidably disposed within pressure tube 230 and divides working chamber 242 into an upper working chamber 244 and a lower working chamber 246. A seal 248 is disposed between piston assembly 232 and pressure tube 230 to permit sliding movement of piston assembly 232 with respect to pressure tube 230 without generating undue frictional forces as well as sealing upper working chamber 244 from lower working chamber 246. Piston rod 234 is attached to piston assembly 232 and it extends through upper working chamber 244 and through an upper end cap or rod guide 250 which closes the upper end of pressure tube 230. A sealing system seals the interface between rod guide 250, pressure tube 230 and piston rod 234. The end of piston rod 234 opposite to piston assembly 232 is adapted to be secured to the sprung mass of vehicle 10. The end of pressure tube 230 opposite to rod guide 250 is closed by a base cup 254 which is adapted to be connected to the unsprung mass of vehicle 10.

A compression valve assembly 260 associated with piston assembly 232 controls movement of fluid between lower working chamber 246 and upper working chamber 244 during compression movement of piston assembly 232 within pressure tube 230. The design for compression valve assembly 260 controls the damping characteristics for shock absorber 210 during a compression stroke. An extension valve assembly 264 associated with piston assembly 232 controls movement of fluid between upper working chamber 244 and lower working chamber 246 during extension or rebound movement of piston assembly 232 within pressure tube 230. The design for extension valve assembly 264 controls the damping characteristics for shock absorber 210 during an extension or rebound stroke.

Because piston rod 234 extends only through upper working chamber 244 and not lower working chamber 246, movement of piston assembly 232 with respect to pressure tube 230 causes a difference in the amount of fluid displaced in upper working chamber 244 and the amount of fluid displaced in lower working chamber 246. The difference in the amount of fluid displaced is known as the “rod volume” and compensation for this fluid is accommodated by a piston 270 slidably disposed within pressure tube 230 and located between lower working chamber 246 and a compensation chamber 272. Typically compensation chamber 272 is filled with a pressurized gas and piston 270 moves within pressure tube 230 to compensate for the rod volume concept.

Referring now to FIG. 6, the attachment between base cup 254 and pressure tube 230 is shown in greater detail. Base cup 254 comprises a cup shaped end cap 310 and a cylindrical attachment collar 312. Collar 312 is illustrated as being welded to end cap 310 but other attachment means or an integral construction can be utilized for collar 312 and end cap 310. End cap 310 defines a mounting bore 314 having an inner cylindrical wall 316 and an annular end wall 318. Pressure tube 230 is inserted into mounting bore 314 such that it does not abut end wall 318. A clearance 320 is maintained between the end 322 of pressure tube 230 and end wall 318. A press fit between pressure tube 230 and cylindrical wall 316 may be provided. Once properly positioned to define clearance 320, end cap 310 and pressure tube 230 are welded as illustrated at 324 such that end cap 310 seals pressure tube 230.

By providing clearance 320, the notch effect is avoided and/or delayed to provide significant improvements in the endurance performance characteristics for high loads for shock absorber 210.

The description of the invention is merely exemplary in nature and, thus, variations that do not depart from the gist of the invention are intended to be within the scope of the invention. Such variations are not to be regarded as a departure from the spirit and scope of the invention.

1-9. (canceled)

10. A shock absorber comprising:
a pressure tube forming a working chamber;
a piston slidably engaging said pressure tube within said working chamber, said piston dividing said working chamber into an upper working chamber and a lower working chamber;
a piston rod attached to said piston, said piston rod extending through one end of said pressure tube;
a reserve tube surrounding said pressure tube to form a reserve chamber between said reserve tube and said pressure tube;
a base cup press fit to one end of said reserve tube to close said one end of said reserve tube, said base cup defining an attachment bore having a step-free inner cylindrical wall terminating at an annular planar bottom surface disposed generally perpendicular to the inner cylindrical wall, a space being formed between said one end of said reserve tube and the bottom surface of said attachment bore.

11. The shock absorber according to claim 10 wherein said base cup is welded to an outer surface of said reserve tube.

12. (canceled)

13. A shock absorber comprising:
a pressure tube forming a working chamber;
a piston slidably engaging said pressure tube within said working chamber, said piston dividing said working chamber into an upper working chamber and a lower working chamber;
a piston rod attached to said piston, said piston rod extending through one end of said pressure tube;
a base cup press fit to the other end of said pressure tube to close said other end of said pressure tube, said base cup defining an attachment bore having a step-free inner cylindrical and wall terminating at an annular planar bottom surface disposed generally perpendicular to the inner cylindrical wall, a space being formed between the other end of said pressure tube and said annular planar bottom surface of said attachment bore.

14. The shock absorber according to claim 13 wherein said said base cup is welded to an outer surface of said pressure tube.

15. (canceled)
